(19) United States
(12) Patent Application Publication
(10) Pub. No.: US 2025/0246842 A1
(43) Pub. Date: Jul. 31, 2025

(54) CHARGING LID CONTROL DEVICE AND CHARGING LID CONTROL METHOD

(71) Applicant: AISIN CORPORATION, Kariya (JP)

(72) Inventors: Tomoya YOKOI, Kariya-shi (JP); Yoshimasa ASANO, Kariya-shi (JP); Toshiro MAEDA, Kariya-shi (JP)

(73) Assignee: AISIN CORPORATION, Kariya (JP)

(21) Appl. No.: 18/692,993

(22) PCT Filed: Oct. 11, 2022
(86) PCT No.: PCT/JP2022/037818

§ 371 Date: Aug. 26, 2024

(30) Foreign Application Priority Data
Nov. 19, 2021 (JP) 2021-188423

(51) Int. Cl. H01R 13/453; B60L 1/00; B60L 53/16

(52) U.S. Cl. CPC H01R 13/4532; B60L 1/003; B60L 53/16; B60L 2260/46; H01R 2201/26

(57) ABSTRACT

A charging lid control device includes an opening and closing control part to open and close a charging lid by an electric motor, and a position estimating part to estimate a position of the charging lid after the charging lid is opened and closed on the basis of a rotation amount of an output shaft of the electric motor accompanying the charging lid being opened and closed, thereby acquiring an estimated position of the charging lid. The position estimating part performs a learning process for relearning the estimated position of the charging lid when the estimated position of the charging lid is not a fully closed position and attachment of a charging connector to a charging port is detected.

### TECHNICAL FIELD

The present disclosure relates to a charging lid control device and a charging lid control method.

### BACKGROUND ART

Patent Literature 1 describes a charging lid opening and closing device including a charging lid that opens and closes a charging port of a vehicle, and an opening and closing state detection part that detects an opening and closing state of the charging lid.

### CITATION LIST

### Patent Literature

Patent Literature 1: JP 2020-31489 A

### BRIEF SUMMARY

### Technical Problems

The opening and closing state detection part as described above detects the opening and closing state of the charging lid on the basis of, for example, a displacement of a movable portion such as a lever. Therefore, when the movable portion is frozen or fixed, the opening and closing state detection part as described above may not be able to normally detect the opening and closing state of the charging lid.

### Solutions to Problems

According to one aspect of the present disclosure, a charging lid control device is provided. The charging lid control device is applied to a vehicle having a charging port to which a charging connector is attached. The vehicle includes a charging lid configured to be displaced between a fully closed position where the charging port is covered and a fully opened position where the charging port is exposed, and an electric motor configured to drive the charging lid. The charging lid control device includes: an opening and closing control part configured to open and close the charging lid by the electric motor; and a position estimating part configured to estimate a position of the charging lid after the charging lid is opened and closed on the basis of a rotation amount of an output shaft of the electric motor accompanying the charging lid being opened and closed, thereby acquiring an estimated position of the charging lid. The position estimating part is configured to perform, when the estimated position of the charging lid is not the fully opened position and attachment of the charging connector to the charging port is detected, a learning process for relearning the estimated position of the charging lid.

According to another aspect of the present disclosure, a charging lid control method is provided. The charging lid control method is applied to a vehicle having a charging port to which a charging connector is attached. The vehicle includes a charging lid configured to be displaced between a fully closed position where the charging port is covered and a fully opened position where the charging port is exposed, and an electric motor configured to drive the charging lid. The charging lid control method includes: opening and closing the charging lid by the electric motor; and estimating a position of the charging lid after the charging lid is opened and closed on the basis of a rotation amount of an output shaft of the electric motor accompanying the charging lid being opened and closed, thereby acquiring an estimated position of the charging lid. The estimating the position of the charging lid includes performing, when the estimated position of the charging lid is not the fully opened position and attachment of the charging connector to the charging port is detected, a learning process for relearning the estimated position of the charging lid.

### BRIEF DESCRIPTION OF DRAWINGS

FIG. 1 is a block diagram illustrating an electrical configuration of a vehicle.

FIG. 2 is a perspective view illustrating components related to a charging port of the vehicle of FIG. 1.

FIG. 3 is a flowchart for explaining a flow of a process performed by a lid control device of the vehicle of FIG. 1 when a charging connector is attached to the charging port.

### DESCRIPTION OF EMBODIMENTS

Hereinafter, an embodiment of a charging lid control device (hereinafter, also referred to as a “lid control device”) will be described with reference to the drawings.

### <Vehicle 10>

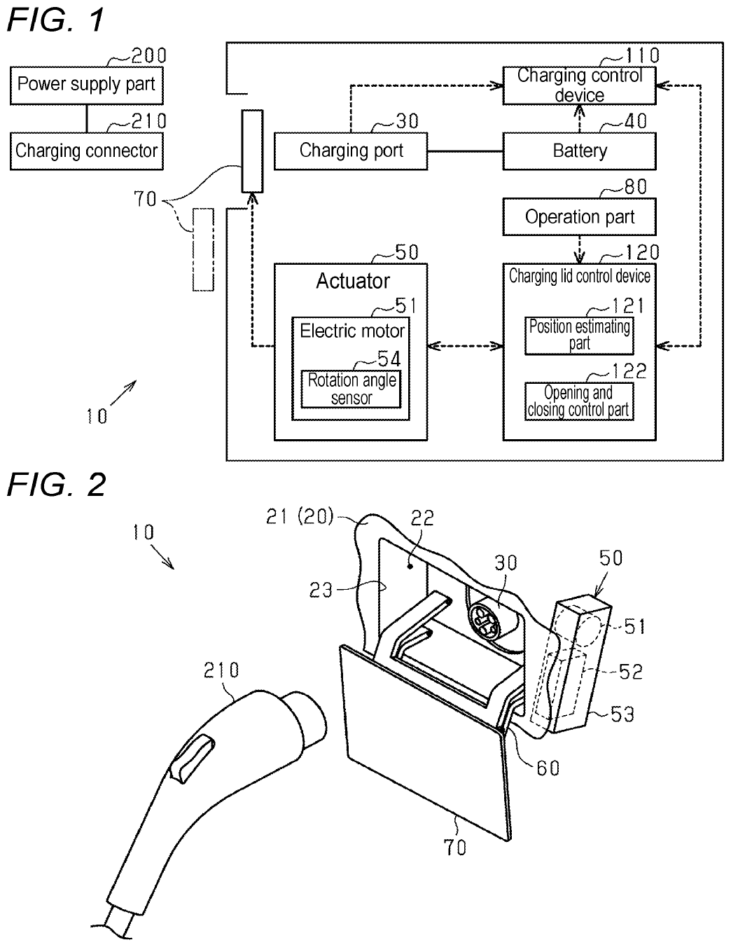

As illustrated in FIGS. 1 and 2, a vehicle 10 includes a vehicle body 20, a charging port 30, a battery 40, a lid actuator 50, a transmission mechanism 60, a charging lid 70, an operation part 80, a charging control device 110, and a lid control device 120. The vehicle 10 of the present embodiment is, for example, an electric car or a hybrid car including a motor generator.

### <Vehicle Body 20>

As illustrated in FIG. 2, the vehicle body 20 includes a body panel 21 constituting the exterior of the vehicle 10, and a housing recess 22 in which the charging port 30 is provided. The housing recess 22 is provided, for example, on a side portion of the body panel 21. In the following description, the opening of the housing recess 22 is also referred to as a lid opening 23.

### <Charging Port 30>

The charging port 30 is a portion to which a charging connector 210 to be connected to a power supply part 200 is attached. The charging port 30 is provided in the housing recess 22. The charging port 30 may have a charging port to which a charging connector for quick charging is attached and a charging port to which a charging connector for normal charging is attached. As illustrated in FIG. 1, the charging port 30 outputs a signal, indicating whether or not the charging connector 210 is attached, to the charging control device 110. The power supply part 200 is a commercial charging stand, a home charging device, or the like.

### <Battery 40>

The battery 40 is a secondary battery such as a lithium ion battery. As illustrated in FIG. 1, the battery 40 is connected to the charging port 30 via an electrical wire. The battery 40 is charged by power supplied via the charging port 30. When AC power is supplied via the charging port 30, power converted into DC is supplied to the battery 40. The battery 40 outputs a signal, indicating a state of charge (hereinafter, also referred to as “SOC”), to the charging control device 110.

### <Lid Actuator 50>

As illustrated in FIGS. 1 and 2, the lid actuator 50 includes an electric motor 51, a reduction mechanism 52 that reduces a rotational speed of an output shaft of the electric motor 51, and a case 53 that houses the electric motor 51 and the reduction mechanism 52. The electric motor 51 is, for example, a brushless motor. As illustrated in FIG. 1, the electric motor 51 includes a rotation angle sensor 54 that detects a rotation angle of the output shaft of the electric motor 51. The rotation angle sensor 54 outputs a detection signal to the lid control device 120. In the present embodiment, the rotation angle sensor 54 includes two or more Hall ICs arranged at intervals in the circumferential direction of the output shaft of the electric motor 51. That is, the rotation angle sensor 54 outputs two or more pulse signals in accordance with an amount of rotation of the output shaft of the electric motor 51. Here, the amount of rotation of the output shaft of the electric motor 51 is equal to the amount of rotation of a rotor of the electric motor 51.

### <Transmission Mechanism 60>

The transmission mechanism 60 is configured to transmit the power of the lid actuator 50 to the charging lid 70. In the present embodiment, the transmission mechanism 60 has a link that connects the vehicle body 20 and the charging lid 70. The transmission mechanism 60 may be configured to transmit the power by a cam or may be configured to transmit the power by a gear.

### <Charging Lid 70>

The charging lid 70 has a rectangular plate shape that is one size larger than the opening edge of the lid opening 23. Based on the power transmitted from the lid actuator 50, the charging lid 70 is opened and closed between a fully closed position where the lid opening 23 is fully closed and a fully opened position where the lid opening 23 is fully opened. In the present embodiment, the charging lid 70 is opened and closed by being swung in the vehicle vertical direction with the plate thickness direction facing the vehicle width direction. In another embodiment, the charging lid 70 may be configured to be opened and closed by being rotated about an axis extending in the vehicle width direction or the vehicle vertical direction. In the following description, operating the charging lid 70 in the closing direction is also referred to as a closing operation, and operating the charging lid 70 in the opening direction is also referred to as an opening operation.

When the charging lid 70 is located at the fully closed position, the charging port 30 is covered by the charging lid 70. That is, when the charging lid 70 is located at the fully closed position, the charging connector 210 cannot be attached to the charging port 30. On the other hand, when the charging lid 70 is located at the fully opened position, the charging port 30 is exposed. That is, when the charging port 30 is located at the fully opened position, the charging connector 210 can be attached to the charging port 30. In this respect, the fully opened position for the charging lid 70 may be a position where the charging connector 210 attached to the charging port 30 does not interfere with the charging lid 70.

When the charging lid 70 is located at the fully closed position, the charging lid 70 is in contact with the opening edge of the lid opening 23 in the closing direction. Therefore, the charging lid 70 cannot be closed from the fully closed position. In other words, if the closing operation of the charging lid 70 is continued from an arbitrary position, the charging lid 70 is locked at the fully closed position. On the other hand, when the charging lid 70 is located at the fully opened position, the transmission mechanism 60 interferes. In this case, the charging lid 70 can be closed but cannot be opened. In other words, if the opening operation of the charging lid 70 is continued from an arbitrary position, the charging lid 70 is locked at the fully opened position. Here, the charging lid 70 being locked means that the charging lid 70 becomes non-displaceable, in other words, the output shaft of the electric motor 51 becomes non-rotatable.

### <Operation Part 80>

The operation part 80 is a part to be operated by the user, and is a part that receives from the user an opening operation request and a closing operation request for the charging lid 70. When operated by the user, the operation part 80 outputs to the lid control device 120 an opening operation command signal for opening the charging lid 70 or a closing operation command signal for closing the charging lid 70. The operation part 80 is preferably arranged in the charging lid 70 or near the charging lid 70. The operation part 80 can also be provided, for example, in a portable device of the vehicle 10. The operation part 80 may separately include a switch for outputting the opening operation command signal and a switch for outputting the closing operation command signal.

### <Charging Control Device 110>

The charging control device 110 determines whether or not the charging connector 210 has been attached to the charging port 30. The charging control device 110 may determine whether or not the charging connector 210 has been attached on the basis of a detection result from a sensor provided in the charging port 30, or may determine whether or not the charging connector 210 has been attached on the basis of whether or not communication with the power supply part 200 has become possible.

The charging control device 110 controls charging of the battery 40. For example, the charging control device 110 controls the charging speed for the battery 40, notifies the user of the vehicle 10 of information on the SOC of the battery 40, and diagnoses the state of the battery 40. The charging control device 110 is communicably connected to the lid control device 120. When detecting that the charging connector 210 has been attached to the charging port 30, the charging control device 110 outputs a signal to that effect to the lid control device 120.

### <Lid Control Device 120>

The lid control device 120 includes a position estimating part 121 that estimates the position of the charging lid 70, and an opening and closing control part 122 that drives the electric motor 51 of the lid actuator 50 to open and close the charging lid 70.

The position estimating part 121 acquires the estimated position of the charging lid 70 on the basis of a detection signal from the rotation angle sensor 54. As described above, the charging lid 70 is opened and closed with the output shaft of the electric motor 51 rotating, and thus the rotation amount of the output shaft of the electric motor 51 correlates with the operation amount of the charging lid 70. In other words, the number of pulses output from the rotation angle sensor 54 correlates with the operation amount of the charging lid 70. Therefore, when the charging lid 70 is opened and closed, the position estimating part 121 acquires the estimated position of the charging lid 70 after the charging lid 70 is opened and closed, by adding or subtracting the operation amount of the charging lid 70, in accordance with the number of pulses output from the rotation angle sensor 54, to or from the estimated position of the charging lid 70 before the charging lid 70 is opened and closed. Here, the rotation angle sensor 54 includes two or more Hall ICs, and thus the position estimating part 121 can accurately acquire, in addition to the rotation amount of the output shaft of the electric motor 51, the rotation direction.

When receiving the opening operation command signal from the operation part 80, the opening and closing control part 122 opens the charging lid 70 from the fully closed position to the fully opened position. When receiving the closing operation command signal from the operation part 80, the opening and closing control part 122 closes the charging lid 70 from the fully opened position to the fully closed position. Here, when the charging lid 70 is operated from one position of the fully closed position and the fully opened position to the other position, the number of pulses output by the rotation angle sensor 54 is defined as a reference number of pulses. When operating the charging lid 70 from one position of the fully closed position and the fully opened position to the other position, the opening and closing control part 122 counts the number of pulses output by the rotation angle sensor 54 after starting the operation of the charging lid 70. Then, the opening and closing control part 122 determines whether or not the integrated value of the number of pulses has reached the reference number of pulses, thereby determining whether or not the charging lid 70 has reached the other position. Thus, the opening and closing control part 122 can stop the charging lid 70 at the fully opened position when opening the charging lid 70 from the fully closed position. Similarly, the opening and closing control part 122 can stop the charging lid 70 at the fully closed position when closing the charging lid 70 from the fully opened position.

In the present embodiment, the position estimating part 121 acquires the estimated position of the charging lid 70 in accordance with the number of pulses output from the rotation angle sensor 54, as described above. Therefore, when the charging lid 70 is displaced under a situation where the number of pulses output from the rotation angle sensor 54 cannot be acquired, the estimated position of the charging lid 70 by the position estimating part 121 may deviate from the actual position. For example, if the user displaces the charging lid 70 when the system power supply of the vehicle 10 is off and the battery 40 is removed from the vehicle 10, and the like, the estimated position of the charging lid 70 by the position estimating part 121 may deviate from the actual position.

Therefore, when the estimated position of the charging lid 70 deviates from the actual position, the position estimating part 121 performs a learning process for relearning the estimated position of the charging lid 70. Hereinafter, the learning process will be described in detail.

When the charging connector 210 is attached to the charging port 30 under a situation where the estimated position of the charging lid 70 is not the fully opened position, the position estimating part 121 can recognize that the estimated position of the charging lid 70 is erroneous. In this case, the position estimating part 121 waits until the closing operation command signal is transmitted. Then, when the closing operation command signal for the charging lid 70 is transmitted, the opening and closing control part 122 continues the closing operation of the charging lid 70 until the charging lid 70 is locked. Then, the position estimating part 121 sets the position, where the charging lid 70 is locked, to the fully closed position. The situation, where the estimated position of the charging lid 70 is not the fully opened position, is a situation where the estimated position of the charging lid 70 is the fully closed position, a situation where the estimated position of the charging lid 70 is an intermediate position between the fully closed position and the fully opened position, or the like.

Here, when the charging lid 70 is locked, in other words, when the rotation of the output shaft of the electric motor 51 is locked, the rotation angle sensor 54 does not output a pulse. When the rotation of the output shaft of the electric motor 51 is locked, the current to flow through the electric motor 51 increases. Based on such a change, the position estimating part 121 may determine whether or not the charging lid 70 has been locked.

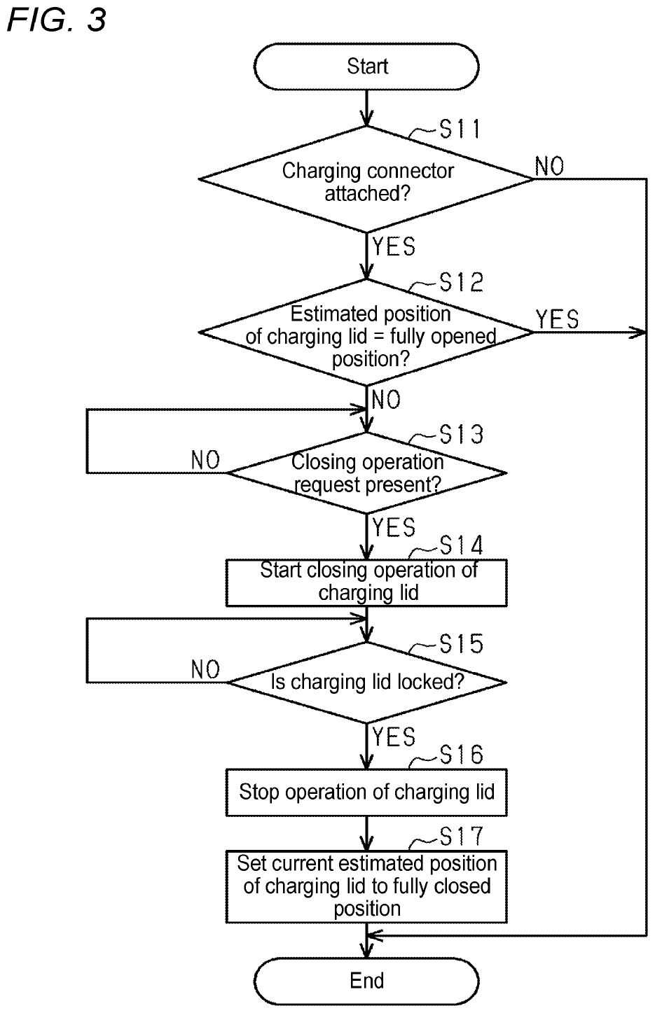

Hereinafter, the flow of the process performed by the lid control device 120 will be described with reference to the flowchart illustrated in FIG. 3.

As illustrated in FIG. 3, the lid control device 120 determines based on a signal input from the charging control device 110 whether or not the charging connector 210 has been attached to the charging port 30 (S11). When the charging connector 210 is not attached (S11:NO), the lid control device 120 once ends the present process. On the other hand, when the charging connector 210 is attached (S11: YES), the lid control device 120 determines whether or not the estimated position of the charging lid 70 is the fully opened position (S12). When the estimated position of the charging lid 70 is the fully opened position (S12: YES), that is, when the estimated position of the charging lid 70 does not deviate from the actual position, the lid control device 120 once ends the present process.

When the estimated position of the charging lid 70 is not the fully opened position (S12:NO), that is, when the estimated position of the charging lid 70 deviates from the actual position, the lid control device 120 performs the learning process from steps S13 to S17.

The lid control device 120 determines whether or not there is the closing operation request for the charging lid 70 via the operation part 80 (S13). When there is no closing operation request for the charging lid 70 (S13NO), the lid control device 120 waits until there is the closing operation request for the charging lid 70 from the user. On the other hand, when there is the closing operation request for the charging lid 70 (S13: YES), the lid control device 120 starts the closing operation of the charging lid 70 (S14). That is, the output shaft of the electric motor 51 of the lid actuator 50 starts to rotate. Thereafter, the lid control device 120 determines whether or not the charging lid 70 has been locked (S15).

When the charging lid 70 is not locked (S15:NO), that is, when the charging lid 70 is in the closing operation between the fully opened position and the fully closed position, the lid control device 120 waits. On the other hand, when the charging lid 70 has been locked (S15: YES), that is, when the charging lid 70 has reached the fully closed position, the lid control device 120 stops the closing operation of the charging lid 70 (S16). That is, the lid control device 120 stops the driving of the electric motor 51 of the lid actuator 50. Subsequently, the lid control device 120 sets the current estimated position of the charging lid 70 to the fully closed position (S17). Then, the lid control device 120 ends the present process.

### Actions and Effects of Present Embodiment

(1) The lid control device 120 estimates the position of the charging lid 70 after the charging lid 70 is opened and closed by considering the rotation amount of the output shaft of the electric motor 51 accompanying the charging lid being opened and closed on the position of the charging lid 70 before the charging lid 70 is opened and closed. Therefore, the lid control device 120 can open and close the charging lid 70 between the fully closed position and the fully opened position without including a switch for detecting the fully closed position and the fully opened position of the charging lid 70. When the estimated position of the charging lid 70 deviates from the actual position for some reason, the lid control device 120 performs a learning process for relearning the estimated position. Therefore, the lid control device 120 can suppress opening and closing the charging lid 70 based on the wrong estimated position.

(2) The lid control device 120 can perform the learning process when the charging lid 70 is closed in response to the closing operation request from the user of the vehicle 10. In other words, the lid control device 120 does not need to open and close the charging lid 70 to separately perform the learning process.

(3) The position estimating part 121 acquires the estimated position of the charging lid 70 on the basis of an output signal from the rotation angle sensor 54. Therefore, the lid control device 120 can enhance the estimation accuracy of the estimated position of the charging lid 70.

### Modifications

The present embodiment can be implemented by being modified as follows. The present embodiment and the following modifications can be implemented in combination with each other within a range not technically contradictory.
When the opening operation command signal for the charging lid 70 is transmitted, the opening and closing control part 122 may continue the opening operation of the charging lid 70 until the charging lid 70 is locked. Then, in the learning process, the position estimating part 121 may set the position, where the charging lid 70 is locked, to the fully opened position. In this modification, the estimated position of the charging lid 70 can be learned before the closing operation request from the user is received, in other words, even in a state where the charging connector 210 is attached to the charging port 30.
When the charging connector 210 is attached to the charging port 30, there is a high possibility that the charging lid 70 may be located at the fully opened position. Therefore, when the charging connector 210 is attached to the charging port 30 and the estimated position of the charging lid 70 is not the fully opened position, the lid control device 120 may set the estimated position of the charging lid 70 to the fully opened position as the learning process. In this case, the charging lid 70 may be configured to allow the charging connector 210 to be attached to the charging port 30 only when the charging lid 70 is located at the fully opened position.
The electric motor 51 of the lid actuator 50 may not include the rotation angle sensor 54. In this case, the lid control device 120 preferably estimates the position of the rotor by detecting the induced voltage of each phase coil of the electric motor 51.
The rotation angle sensor 54 may be one Hall IC. In addition, the rotation angle sensor 54 may be an optical sensor or an electromagnetic induction sensor.
The charging control device 110 and the lid control device 120 may be integrated as one ECU.
The charging control device 110 and the lid control device 120 can be configured as a processing circuit including one or more processors that operate according to a computer program (software). In addition, the charging control device 110 and the lid control device 120 can be configured as a processing circuit including one or more dedicated hardware circuits such as dedicated hardware (application specific integrated circuit: ASIC) that executes at least some processing of the various processing. Furthermore, the charging control device 110 and the lid control device 120 can be configured as a processing circuit including a combination thereof. The processor includes a CPU and memories such as a RAM and a ROM. The memory stores a program code or a command configured to cause the CPU to execute processing. The memory, that is, a computer-readable medium, includes any available medium that can be accessed by a general-purpose or dedicated computer.

1. A charging lid control device applied to a vehicle having a charging port to which a charging connector is attached, the vehicle including a charging lid configured to be displaced between a fully closed position where the charging port is covered and a fully opened position where the charging port is exposed, and an electric motor configured to drive the charging lid, the charging lid control device comprising:
an opening and closing control part configured to open and close the charging lid by the electric motor; and
a position estimating part configured to estimate a position of the charging lid after the charging lid is opened and closed on the basis of a rotation amount of an output shaft of the electric motor accompanying the charging lid being opened and closed, thereby acquiring an estimated position of the charging lid, wherein
the position estimating part is configured to perform, when the estimated position of the charging lid is not the fully opened position and attachment of the charging connector to the charging port is detected, a learning process for relearning the estimated position of the charging lid.

2. The charging lid control device according to claim 1, wherein
the charging lid is configured to not be closed from the fully closed position,
the opening and closing control part is configured to continue, when a closing operation request for the charging lid is received, a closing operation of the charging lid until it is detected that the charging lid is locked in which the charging lid becomes non-displaceable, and
when there is the closing operation request for the charging lid, the position estimating part sets a position, where it is detected that the charging lid is locked, to the fully closed position in the learning process.

3. The charging lid control device according to claim 1, wherein
the charging lid is configured to not be opened from the fully opened position,
the opening and closing control part is configured to continue, when an opening operation request for the charging lid is received, an opening operation of the charging lid until it is detected that the charging lid is locked in which the charging lid becomes non-displaceable, and
the position estimating part sets a position, where it is detected that the charging lid is locked, to the fully opened position in the learning process.

4. The charging lid control device according to claim 1, wherein
the electric motor includes a rotation angle sensor configured to detect a rotation angle of an output shaft of the electric motor, and
the position estimating part is configured to acquire the estimated position of the charging lid on the basis of an output signal from the rotation angle sensor.

5. A charging lid control method applied to a vehicle having a charging port to which a charging connector is attached, the vehicle including a charging lid configured to be displaced between a fully closed position where the charging port is covered and a fully opened position where the charging port is exposed, and an electric motor configured to drive the charging lid, the charging lid control method comprising:
opening and closing the charging lid by the electric motor; and
estimating a position of the charging lid after the charging lid is opened and closed on the basis of a rotation amount of an output shaft of the electric motor accompanying the charging lid being opened and closed, thereby acquiring an estimated position of the charging lid, wherein
estimating the position of the charging lid includes performing, when the estimated position of the charging lid is not the fully opened position and attachment of the charging connector to the charging port is detected, a learning process for relearning the estimated position of the charging lid.
